(19) United States
(12) Patent Application Publication
(10) Pub. No.: US 2012/0106351 A1
(43) Pub. Date: May 3, 2012

(54) Determining a Logic State of a Device

(76) Inventors: Tushar K. Gohel, Winchester, MA (US); Benjamin F. Mitchel, Spencer, MA (US)

(21) Appl. No.: 13/288,776

(22) Filed: Nov. 3, 2011

Related U.S. Application Data
(60) Provisional application No. 61/409,564, filed on Nov. 3, 2010.

(51) Int. Cl. H04L 12/26

(52) U.S. Cl. 370/241

(57) ABSTRACT

A system includes a driver device configured to transmit a first signal through a communication line to a device that is external to the system; wherein the communication line is configured to (i) receive signals from the system and to transmit signals to the system, and (ii) receive signals from the device that is external to the system and to transmit signals to the device that is external to the system; a reference device configured to generate a reference value; and a receiver configured to: receive, through the communication line, a second signal affected by an output from the device that is external to the system; and determine a logic state of the device external to the system based on: a value associated with the second signal on the communication line; a value associated with the first signal transmitted by the driver device; and the reference value.

### CLAIM OF PRIORITY

This application claims priority under 35 U.S.C. §119(e) to provisional U.S. Patent Application 61/409,564, filed on Nov. 3, 2010, the entire contents of which are hereby incorporated by reference.

### BACKGROUND

In an example, a circuit may include a half-duplex communication line. Generally, a half-duplex communication line includes a communication line that may be used for both transmission of and receipt of data. The circuit may be configured to switch among various states for driving signals and/or for receiving signals. In a transmitting state, the circuit uses the driver device to send a signal over the half-duplex communication line to a device. In a receiving state, the circuit uses the half-duplex communication line to receive a signal from the device. The circuit switches from the transmitting state to the receiving state by disabling an output of the driver, which generates periods of latency during operation of the circuit.

### SUMMARY

In one aspect of the present disclosure, a system includes a driver device configured to transmit a first signal through a communication line to a device that is external to the system; wherein the communication line is configured to (i) receive signals from the system and to transmit signals to the system, and (ii) receive signals from the device that is external to the system and to transmit signals to the device that is external to the system; a reference device configured to generate a reference value; and a receiver configured to: receive, through the communication line, a second signal affected by an output from the device that is external to the system; and determine a logic state of the device external to the system based on: a value associated with the second signal on the communication line; a value associated with the first signal transmitted by the driver device; and the reference value generated by the reference device.

Implementations of the disclosure can include one or more of the following features. In some implementations, the receiver is further configured to: receive a value that is derived from the value associated with the second signal on the communication line and the value associated with the first signal transmitted by the driver device. In other implementations, the value received by the receiver includes a first value, and the receiver is further configured to: receive a second value that is derived from the reference value and the value associated with the first signal transmitted by associated with the driver device.

In other implementations, the receiver is further configured to: compare the first value to the second value. In some implementations, determination of the logic state based on comparison of the first value to the second value. In still other implementations, the value associated with the second signal on the communication line includes one or more of a voltage value or a current value; wherein the value associated with the first signal transmitted by the driver device includes one or more of a voltage value or a current value; and the reference value generated by the reference device includes one or more of a reference voltage value or a reference current value.

In some implementations, the communication line includes a half-duplex communication line. In other implementations, the device that is external to the system includes one or more of a disk drive, a memory drive, or a solid state drive. In still other implementations, the logic state includes one or more of a high logic state and a low logic state.

In other implementations, at a first time: the first value is greater than the second value; and at a second time: the value of the driver device changes relative to the value of the driver device at the first time; and the first value remains greater than the second value. In some implementations, at a first time: the first value is less than the second value; and at a second time: the value of the driver device changes relative to the value of the driver device at the first time; and the first value remains less than the second value.

In still other implementations, the logic state of the device that is external to the system is based on the second value and the reference value. In some implementations, the first signal adjusts the first value in accordance with a first relationship; the first signal adjusts the second value in accordance with a second relationship; wherein the first relationship is between the first value and the second value; the second relationship is between a value affected by the device that is external to the system and the reference value; and the first relationship is dependent on the second relationship.

In another aspect of the present disclosure, a system includes a first device including a first receiver and a first driver device; a second device including a second receiver and a second driver device; and a communication line for communication between the first device and the second device; wherein the first receiver is configured to determine a first logic state of the second driver device independent of a second logic state of the first driver device; and wherein the second receiver is configured to determine the second logic state of the first driver device independent of the first logic state of the second driver device.

Implementations of the disclosure can include one or more of the following features. In some implementations, the first driver device is configured to transmit one or more first signals from the first device to the second device over the communication line; the first receiver is configured to receive one or more second signals from the second device over the communication line; the second driver device is configured to transmit one or more third signals from the second device to the first device over the communication line; and the second receiver is configured to receive one or more fourth signals from the first device over the communication line. In other implementations, the first logic state includes one of a high logic state or a low logic state.

In still other implementations, the first driver device is configured to transmit one or more first signals to the second receiver device over the communication line at a substantially simultaneous time as the second driver device is configured to transmit one or more second signals to the first receiver device over the communication line.

In still another aspect of the present disclosure, a method implemented by a first device includes receiving, over a communication line, a signal specifying a first value, wherein the communication line is configured for bi-directional communication between the first device and the second device, and wherein the signal is affected by an output of the first device; obtaining a second value from a driver device; obtaining a reference value; determining, based on the first value, the second value, and the reference value, a logic state of the second device.

Implementations of the disclosure can include one or more of the following features. In some implementations, the method includes generating a first summation value based on the first value and the second value; generating a second summation value based on the second value and the reference value; and comparing the first summation value to the second summation value; wherein determining includes: determining based on comparing.

In other implementations, the first summation value includes the first value adjusted by a first amount, with the first amount based on the second value; wherein the second summation value includes the reference value adjusted by a second amount, with the second amount based on the second value; and wherein the first amount offsets the second amount. In still other implementations, comparing the first summation value to the second summation value is substantially the same as comparing a value of a driver of the second device to the reference value

In other implementations, the logic state includes one of a high logic state or a low logic state. In still other implementations, the first value includes one or more of a first voltage value or a first current value; the second value includes one or more of a second voltage value or a second voltage value; and the reference value includes one or more of a reference voltage value or a reference current value.

### DESCRIPTION OF DRAWINGS

FIG. 1 is a perspective view of a disk drive testing system.

FIG. 2 is a perspective view of a test slot assembly.

FIGS. 3 and 5 are block diagrams of devices that use communication lines for bi-directional communication.

FIG. 4 is a flowchart of an example process for determining a logic state of a device.

Like reference symbols in the various drawings indicate like elements.

### DETAILED DESCRIPTION

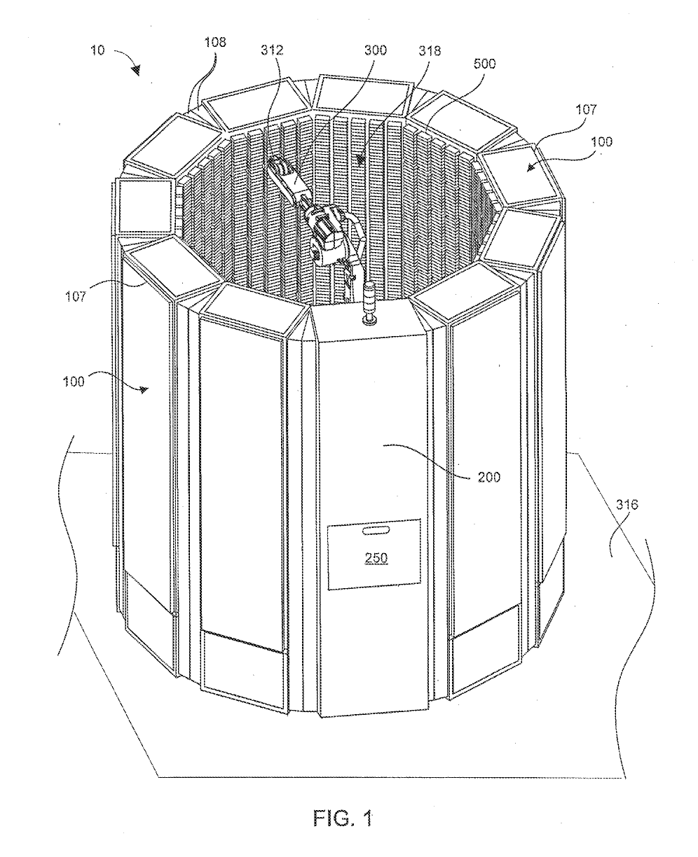

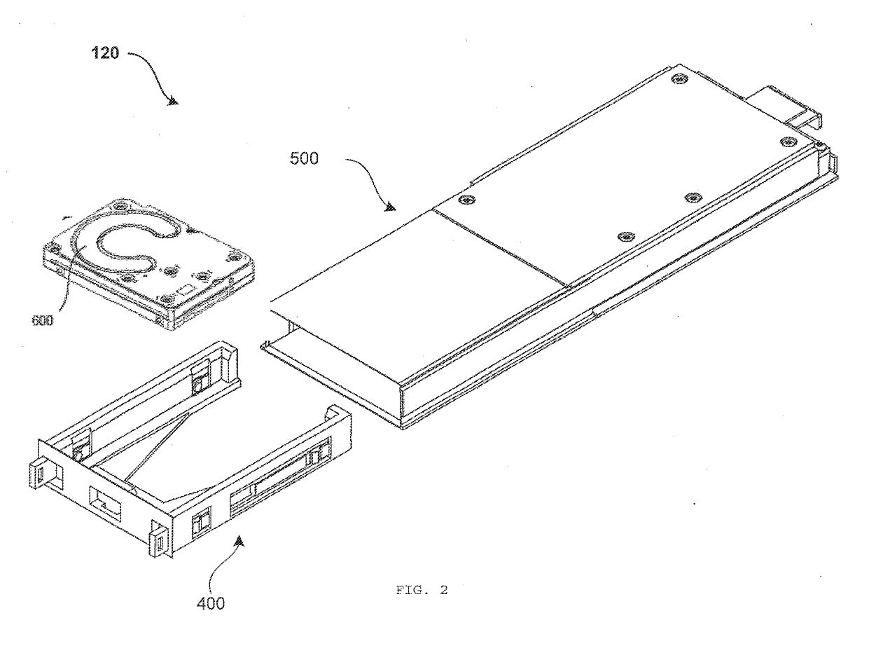

As shown in FIG. 1, a disk drive testing system 10 includes a plurality of test racks 100 (e.g., 10 test racks shown), a transfer station 200, and a robot 300. As shown in FIG. 2, each test slot assembly 120 includes a disk drive transporter 400 and a test slot 500. The disk drive transporter 400 is used for capturing disk drives 600 (e.g., from the transfer station 200) and for transporting the disk drive 600 to one of the test slots 500 for testing. In an example, the test slot 500 may include electrical connectors (not shown) to provide for electrical communication between the disk drive 600 and test electronics (not shown) in the associated test rack 100.

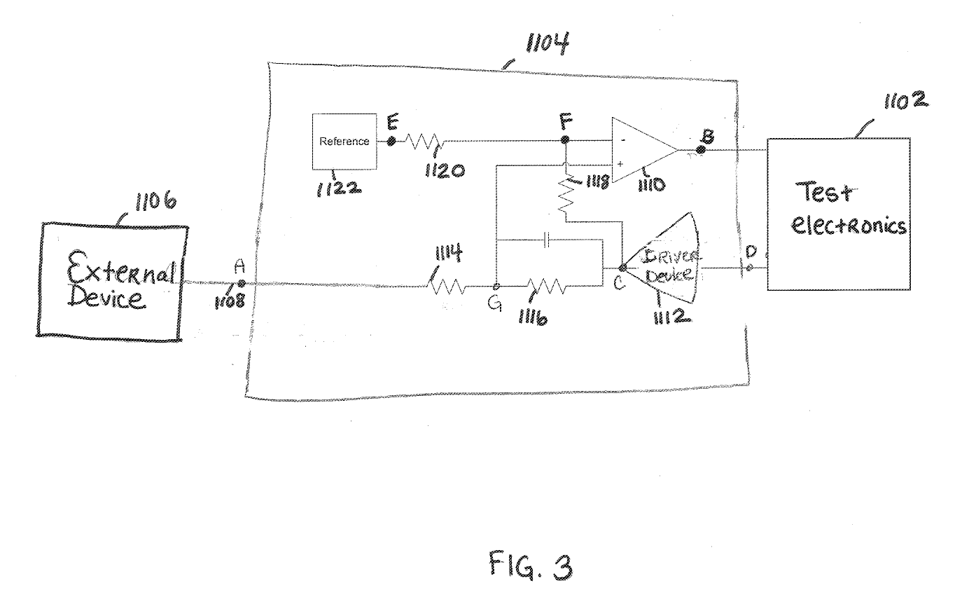

Referring to FIG. 3, the disk drive testing system 10 (FIG. 1) may also include a device 1104 to promote communication between test electronics 1102 of the test slot 500 and an external device 1106 (e.g., disk drive 600). In the example of FIG. 3, the device 1104 includes a communication line 1108, a receiver 1110 and a driver device 1112. In this example, the communication line 1108 includes a half-duplex communication line. Signals are transmitted over the communication 1108 and the signals may have various characteristics that can be determined by various devices. As described herein, the characteristics of a signal transmitted on the communication 1108 are used by the receiver 1110 to determine a logic state of the external device 1106.

The driver device 1112 includes a device for transmitting signals, e.g., to the external device 1106 and/or to the receiver 1110. The receiver device 1110 includes a device for receiving signals, e.g., from the external device 1106 and/or from the driver device 1112.

The communication line 1108 is used for bi-directional communication between the device 1104 and the external device 1106. In an example, a bi-directional communication includes a first communication in which signals received by the device 1104 (e.g., from the test electronics 1102) are transmitted to the external device 1106 and a second communication in which signals received from the external device 1106 are transmitted through the receiver 1110 to the test electronics 1102.

In an example, the receiver 1110 includes a “−” terminal and a “+” terminal. The receiver 1110 is configured to receive one input at the “−” terminal and another input at the “+” terminal. The inputs to the terminals of the receiver 1110 may include voltages, currents, and so forth. The receiver 1110 is configured to compare the inputs received at the terminals. In this example, the receiver 1110 includes a comparator device.

Based on the comparison, the receiver 1110 determines a logic state of the external device 1106 based on the signal on the communication line 1108. Generally, a logic state includes a value that indicates whether a value of the input received at the “+” terminal of the receiver 1110 has an increased value relative to a value of the input received at the “−” terminal of the receiver 1110.

In an example, logic states of the receiver 1110 include a low logic state and a high logic state. In a low logic state, the value of the input received at the “+” terminal is decreased relative to the value of the input received at the “−” terminal. When the receiver 1110 is in a low logic state, the receiver 1110 is configured to output a logic value of zero.

In a high logic state, the value of the input received at the “+” terminal is increased relative to the value of the input received at the “−” terminal. When the receiver 1110 is in a high logic state, the receiver 1110 is configured to output a logic value of one.

In the example of FIG. 3, the driver device 1112 intermittently (e.g., periodically, continuously, at pre-defined time intervals, and so forth) transmits signals to the receiver 1110 and to the external device 1106. The driver device 1112 is programmed by the test electronics 1102 to transmit signals specifying voltage values. In this example, the driver device 1112 is programmed to transmit a low voltage value (e.g., 0V) and a high voltage value (e.g., 5V). In another example, various other low voltage values and high voltage values can be used. The low voltage value has a value that is decreased relative to a value of the high voltage value. The external device 1106 also periodically transmits signals to the receiver 1110. The external device 1106 is also programmed to transmit a low voltage value and a high voltage value.

Similar to the receiver 1110, the driver device 1112 and the external device 1106 also have low logic states and high logic states. When the external device 1106 transmits the low voltage value, the external device 1106 is in a low logic state. When the external device 1106 transmits the high voltage value, the external device 1106 is in a high logic state. When the driver device 1112 transmits the low voltage value, the driver device 1112 is in a low logic state. When the driver device 1112 transmits the high voltage value, the driver device 1112 is in a high logic state.

The device 1104 also includes a reference device 1122 that is programmed with a reference value (e.g., a reference voltage value) that is used by the receiver 1110 in determining a logic state of the external device 1106 based on the signal on the communication line 1108. In a variation of FIG. 3, the reference device 1122 may be a device that is external to device 1104. In another variation, the reference device 1122 may be configured to retrieve the reference voltage value from a device that is external to device 1104.

In an example, the logic state of the external device 1106 is determined by a comparison of a voltage value transmitted by the external device 1106 to the reference voltage value. In this example, the external device 1106 and the driver device 1112 may transmit voltage values to the receiver 1110 at a same time (e.g., simultaneously) and/or at a substantially simultaneous time. The “−” terminal of the receiver 1110 receives as an input a voltage value that is at least partly based on the voltage value transmitted by the driver device 1112 and the voltage reference value of the reference device 1122. The “+” terminal of the receiver 1110 receives as an input a voltage value that is at least partly based on the voltage value transmitted by the external device 1106 and the voltage value transmitted by the driver device 1112. The output voltage of the driver device 1112 adjusts values of inputs to both terminals of the receiver 1110 by an amount that allows the receiver 1110 to determine whether the voltage value transmitted by the external device 1106 is greater than or less than the reference voltage value. By comparing the voltage values received as inputs at the terminals, the receiver 1110 is configured to determine a logic state of the external device 1106 based on the signal on the communication line 1108.

In an example, the receiver 1110 receives as input to its terminals a first input voltage value and a second input voltage value, with each of the input voltage values at least partly based on the voltage value from the driver device 1112. In this example, the first input voltage value is derived from a voltage value associated with the communication line 1108 (e.g., affected by transmissions from the external device 1106 and the driver device 1112) and another voltage value associated with the driver device 1112.

In an example, the voltage value on the communication line 1108 is affected by both the voltage value output by the driver device 1112 and the voltage value output by the external device 1106. In this example, the driver device 1112 and the external device 1106 both output voltage values onto the communication line 1108, e.g., at the same time.

The second input voltage value is derived from the voltage value associated with the driver device 1112 and the reference voltage value. While the driver device 1112 affects the voltage values input to the terminals of the receiver 1110, the device 1104 is configured such that the receiver 1110 effectively compares the voltage value transmitted by a driver in the external device 1106 on to the communication line 1108 to the reference voltage value, as described in further detail below.

In this example, the voltage value provided by the external device 1106 over the communication line 1108 to the receiver 1110 is adjusted (e.g., modified) by the voltage value output by the driver device 1112. The voltage value provided by the reference device 1122 to the receiver 1110 is also adjusted by the voltage value output by the driver device 1112. Based on this configuration, the input to the “+” terminal of the receiver 1110 and the input to the“−” terminal of the receiver 1110 are both adjusted by the voltage value output by the driver device 1112. Based on this adjustment, the logic state of the output of the receiver 1110 matches the logic state of the voltage value transmitted by the external device 1106. In some examples, there may be a delay through the communication line 1108 before the receiver 1110 changes logic states from a high logic state to a low logic state.

In this example, the driver device 1112 and the external device 1106 are configured to simultaneously transmit signals on the communication line 1108. As such, the voltage value on the communication line 1108 may be affected by the output of the driver device 1112 and/or the output of the external device 1106. Using the techniques described herein, the device 1104 is configured to determine a logic state of the external device 1106 without disabling the driver device 1112 (e.g., the driver device 1112 is configured to periodically and/or continuously operate). By the driver device 1112 continuously operating, the device 1104 is configured to decrease an amount of latency generated by disabling and enabling transmission of the driver device 1112.

The reference value voltage of the reference device 1122 promotes the logic state of the output of the receiver 1110 to match the logic state of the external device 1106 based on the signal on the communication line 1108 (e.g., transmitted from the external device 1106 and/or affected by an output of the external device 1106). In an example, the reference voltage value is used in determining whether the external device 1106 is in a low logic state and/or in a high logic state, e.g., based on the voltage value of the communication line 1108.

In an example, the reference voltage value includes a value that is greater than the low voltage value of the external device 1106 and is less than the high voltage value of the external device 1106. In this example, the reference voltage value includes a mean value of the high voltage value and the low voltage value of the external device 1106. In this example, when the voltage value transmitted by the external device 1106 is greater than the reference voltage value, the external device 1106 is in a high logic state. When the voltage value transmitted by the external device 1106 is less than the reference voltage value, the external device 1106 is in a low logic state.

Device 1104 also includes resistors 1114, 1116, 1118, 1120 to weight the voltage values provided by the reference device 1122, the external device 1106, and the driver device 1112. By weighting the voltage values provided by the external device 1106, the driver device 1112, and the reference device 1122, the device 1104 promotes a match between a logic state of the output of the receiver 1110 and a logic state of the external device 1106 based on the signal on the communication line 1108 (e.g., as affected by an output from the external device 1106).

Nodes A, B, C, D, E, F and G are illustrated in FIG. 3 and will be referenced in the below passages. In the example of FIG. 3, node A includes a voltage value that is transmitted by external device 1106. Node B includes a voltage value that is output by the receiver 1110. Node D includes a voltage value that is transmitted by the test electronics 1102 to the driver device 1112. Node C includes a voltage value that is transmitted by the driver device 1112, e.g., and may be the same as the voltage value at node D. The resistors 1114, 1116 generate a voltage divide between the nodes A, C. Node G includes a value that is indicative of the voltage divide between the nodes A, C. The receiver 1110 receives at the “+” terminal the voltage value at node G.

Node E includes the reference voltage value that is transmitted by the reference device 1122. The resistors 1118, 1120 generate a voltage divide between the nodes E, C. Node F includes a value that is indicative of the voltage divide between the nodes E, C. The receiver 1110 receives at the “−” terminal the voltage value at node F.

As previously described, the receiver 1110 compares the input received at the “−” terminal to the input received at the “+” terminal. Based on the comparison, the receiver 1110 determines whether to transmit a low logic state or a high logic state to the test electronics 1102. The receiver 1110 outputs at node B a value indicative of the comparison performed by the receiver 1110. As previously described, the device 1104 is configured to promote a logic state of the output of the receiver 1110 (e.g., at node B) matching a logic state of the external device 1106 based on the signal transmitted on the communication line 1108 (e.g., at node A).

The voltage values of the external device 1106 and the driver device 1112 have low and high voltage values (e.g., values of 0V and 5V, respectively). In this example, when the external device 1106 transmits a high voltage value, the external device 1106 is in a high logic state. When the external device 1106 transmits a low voltage value, the external device 1106 is in a low logic state. As previously described, nodes A and C include the voltage values transmitted by the external device 1106 and the driver device 1112, respectively.

The inputs to the receiver 1110 are at least partly based on the voltage values at nodes A and C, as described above. The below Table 1 provides an illustrative example of how the input at node A corresponds to the output at node B.

TABLE 1

| Input | | Output |
|---|---|---|
| A | C | B |
| 0 | 0 | 0 |
| 1 | 0 | 1 |
| 0 | 1 | 0 |
| 1 | 1 | 1 |

The calculation in the above Table 1 assumes that both the external device 1106 and the driver device 1112 have high voltage values of 5V and low voltage values of 0V and that the reference voltage value is 2.5V. In this example, the output impedance (e.g., resistance) of the external device 1106 is decreased relative to the output impedance generated at least in part by resistors 1114, 1116. In this example, the ratio of the value of resistor 1114 to the value of resistor 1116 and the ratio of the value of resistor 1118 to the value of resistor 1120 are substantially the same.

In this example, the output of the external device 1106 may be enabled when transmitting (e.g., signals to the device 1104) and disabled when receiving (e.g., signals from the device 1104). As previously described, the maximum voltage on the communication line 1108 may be 5V and the minimum voltage on the communication line 1108 may be 0V. In this example, the resistors 1114, 1116, 1118, and 1120 have a same value.

As previously described, a high voltage value of 5V corresponds to a high logic state with a value of one. A low voltage value of 0V corresponds to a low logic state with a value of zero. In this example, when nodes A, C have values indicative of low logic states (e.g., logic states with values of zero), the voltage value at node G has a value 0V, and the voltage value at node F has a value of 1.25V. As previously described, the voltage value at node F is input to the “−” terminal of the receiver 1110, and the voltage value at node G is input to the “+” terminal of the receiver 1110. In this example, the value (e.g., 1.25V) input to the “−” terminal of the receiver 1110 is greater than the value (e.g., 0V) input to the “+” terminal of the receiver 1110. Based on a comparison of the inputs to the terminals, the receiver 1110 determines a low logic state of the output of the receiver 1110. The receiver 1110 outputs at node B a value of 0V, indicative of the low logic state of the output of the receiver 1110.

In another example, node A has a value indicative of a high logic state and node C has a value indicative of a low logic state. In this example, the voltage value at node G has a value 2.5V, and the voltage value a node F has a value of 1.25V. In this example, the value (e.g., 1.25V) at the “−” terminal of the receiver 1110 is less than the value (e.g., 2.5V) at the “+” terminal of the receiver 1110, and the receiver 1110 determines a high logic state (e.g., a logic state with a value of one) for the external device 1106, e.g., based on the signal on the communication line 1108. As previously described, the voltage value of the signal on the communication line 1108 may be affected by an output of the external device 1106 and/or of the driver device 1112. The receiver 1110 outputs at node B a value of 5V, which corresponds to the high logic state of the external device 1106 (e.g., based on the signal on the communication line 1108).

In still another example, node A has a value indicative of a low logic state and node C has a value indicative of a high logic state. In this example, the voltage value at node G has a value of 2.5V, and the voltage value at node F has a value of 3.75V. In this example, the value (e.g., 3.75V) at the “−” terminal of the receiver 1110 is greater than the value (e.g., 2.5V) at the “+” terminal of the receiver 1110, and the receiver 1110 determines a low logic state. The receiver 1110 outputs at node B a value of 0V, which corresponds to the low logic of the signal on the communication line 1108.

In yet another example, node A has a value indicative of a high logic state and node C has a value indicative of a high logic state. In this example, the voltage value at node G has a value 5V, and the voltage value a node F has a value of 3.75V. In this example, the value (e.g., 3.75V) at the “−” terminal of the receiver 1110 is less than the value (e.g., 5V) at the “+” terminal of the receiver 1110, and the receiver 1110 determines that the external device 1106 is in a high logic state. The receiver 1110 outputs at node B a value of 5V, which is indicative of the high logic of the signal on the communication line 1108.

As previously described, the receiver 1110 can determine the logic state of the communication line 1108 by comparing the voltage value of the communication line 1108 to the voltage reference value of the reference device 1122. Because the communication line 1108 is being used for bi-directional communication between the external device 1106 and the driver device 1112, the voltage value transmitted by the driver device 1112 impacts the voltage value received at the “+” terminal of the receiver 1110. That is, the voltage value received at the “+” terminal of the receiver is based on the voltage value transmitted by the external device 1106 and the voltage value transmitted by the driver 1112.

As previously described, the receiver 1110 is configured to compare the voltage value on the communication line 1108 (e.g., transmitted by the external device 1106 and/or affected by the external device 1106) to the reference voltage value. In this example, when the voltage value transmitted by the external device 1106 is adjusted based on the voltage value transmitted by the driver device 1112, the voltage reference value is also adjusted based on the voltage value transmitted by the driver device 1112.

By adjusting the voltage value transmitted by the external device 1106 and the reference voltage value by appropriate amounts determined by a same signal (e.g., an amount that is at least partially based on the voltage value transmitted by the driver device 1112), the impact of the voltage value transmitted by the driver device 1112 is decreased, e.g., relative to not adjusting the voltage reference value an amount that is at least partially based on the voltage value transmitted by the driver device 1112.

Using the foregoing techniques, a signal transmitted from the driver device 1112 adjusts the voltage value on the communication line 1108 in accordance with a first relationship between the voltage value on the communication line 1108 and the voltage value transmitted by the driver device 1112. Generally, a relationship includes a correspondence between two values. For example, a relationship specifies that an increase in one value causes an increase in another value. In another example, another relationship specifies that a decrease in one value causes a decrease in another value. In still another example, another relationship specifies that a decrease in one value causes an increase in another value. The signal transmitted from the driver device 1112 also adjusts the reference voltage value in accordance with a second relationship between the reference voltage value and a voltage value related to an output of a driver of the external device 1106.

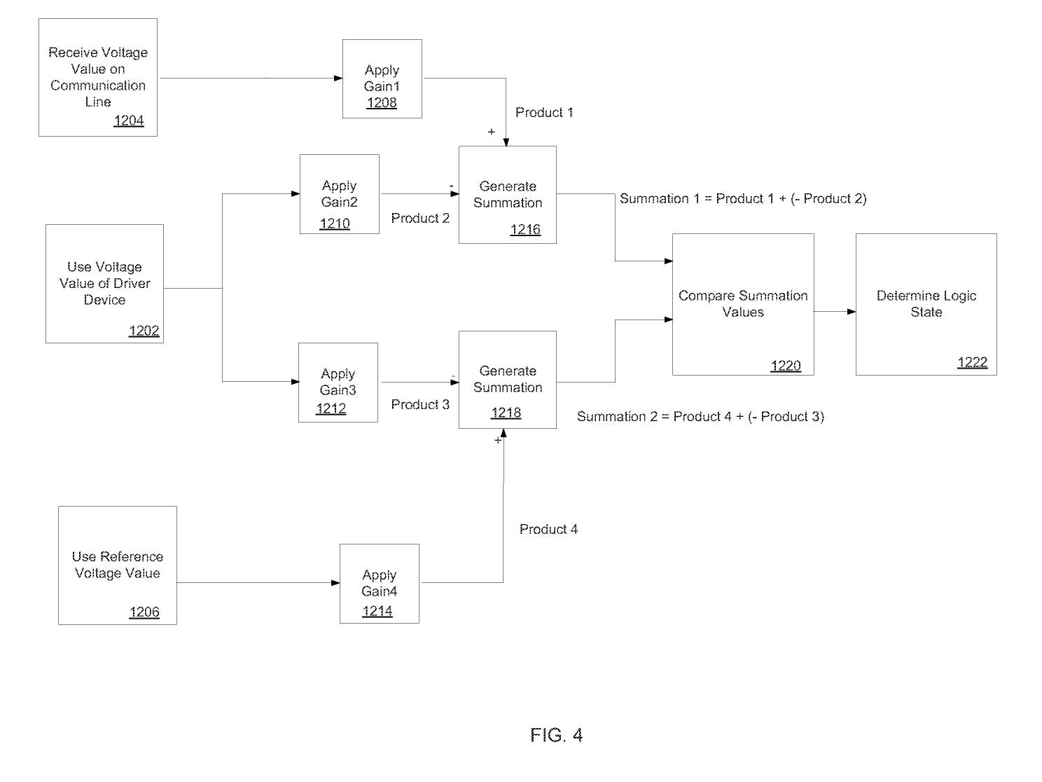

FIG. 4 is a flowchart of an example process 1200 for determining a logic state of the external device 1106 based on the signal on the communication line 1108. In operation, the device 1104 uses (1202) the voltage value transmitted by the driver device 1112. As previously described, the voltage value transmitted by the driver device 1112 may include a low voltage value and/or a high voltage value.

The device 1104 receives (1204) a voltage value on the communication line 1108. As previously described, the voltage value output from the external device 1106 on the communication line 1108 may include a low voltage value and/or a high voltage value. The device 1104 also uses (1206) the voltage reference value transmitted from the reference component 1122.

In the example of FIG. 4, the device 1104 applies (1208) a first gain to the voltage value received from the communication line 1108. In this example, the first gain is applied to the voltage value received from the communication line 1108 through various circuitry included in the device 1104. The first gain may be applied to the voltage value received from the communication line 1108 by generating a first product of the voltage value received from the communication line 1108 and the first gain (e.g., product 1=(voltage value received from the communication line) times (gain1)).

The device 1104 also applies (1210) a second gain to the voltage value transmitted by the driver device 1112. In this example, the second gain is applied to the voltage value transmitted by the driver device 1112 through various circuitry included in the device 1104. The second gain may be applied to the voltage value transmitted by the driver device 1112 by generating a second product of the voltage value transmitted by the driver device 1112 and the second gain (e.g., product 2=(the voltage value transmitted by the driver device 1112) times (gain2)).

The device 1104 generates (1216) a first summation value based on the first product and the second product. Generally, a summation value includes a value indicative of a sum of other values. In the example of FIG. 4, the device 1104 may be configured to apply a negative value to the second product, e.g., as indicated by the “−” sign in box 1216. By applying a negative value to the second product, the device 1104 specifies that the second product is subtracted from the first product. In the example of FIG. 4, the receiver 1110 receives (not shown) the first summation value at the “+” terminal of the receiver 1110.

Based on the foregoing actions, the device 1104 adjusts the voltage value of the communication line 1108 by an amount derived from the voltage value of the driver device 1112. In this example, the first summation value includes the first voltage value adjusted by a first amount, with the first amount based on the voltage value of the driver device 1112. The device 1106 also generates a second summation value to adjust the reference voltage value by a second amount (e.g., an amount derived from the voltage value of the driver device 1112). In this example, the first amount offsets the second amount. Generally, an offset includes a value that counteracts another value. In generation the second summation value, the device 1104 performs the following actions.

In operation, the device 1104 applies (1212) a third gain to the voltage value of the driver device 1112. The third gain may be applied to the voltage value of the driver device 1112 by generating a third product of the voltage value of the driver device 1112 and the third gain (e.g., product 3=(voltage value of the driver device 1112) times (gain3)).

The device 1104 also applies (1214) a fourth gain to the reference voltage value. In this example, the fourth gain is applied to the reference voltage value by generating a fourth product of the reference voltage value and the fourth gain (e.g., product 4=(the reference voltage value) times (gain4)).

The device 1104 generates (1218) a second summation value based on the third product and the fourth product. In the example of FIG. 4, the device 1104 may be configured to apply a negative value to the third product, e.g., as indicated by the “−” sign in box 1218. By applying a negative value to the third product, the device 1104 specifies that the third product is subtracted from the fourth product. In the example of FIG. 4, the receiver 1110 receives (not shown) the second summation value at the “−” terminal. The “+” and “−” signs on summing boxes 1216 and 1218 may be changed by moving the signs back to the gain stages (e.g., gain1, gain2, gain3, and gain4).

The receiver 1110 compares (1220) the first summation value to the second summation value. Based on the comparison, the receiver 1110 determines (1222) a logic state of the external device 1106 based on the signal on the communication line 1108.

As previously described, the receiver 1110 is configured to output a high logic state when the first summation value (e.g., the value of the input at the “+” terminal of the receiver 1110) is greater than the second summation value (e.g., the value of the input at the “−” terminal of the receiver 1110). The receiver 1110 is configured to output a low logic state when the first summation value is less than the second summation value.

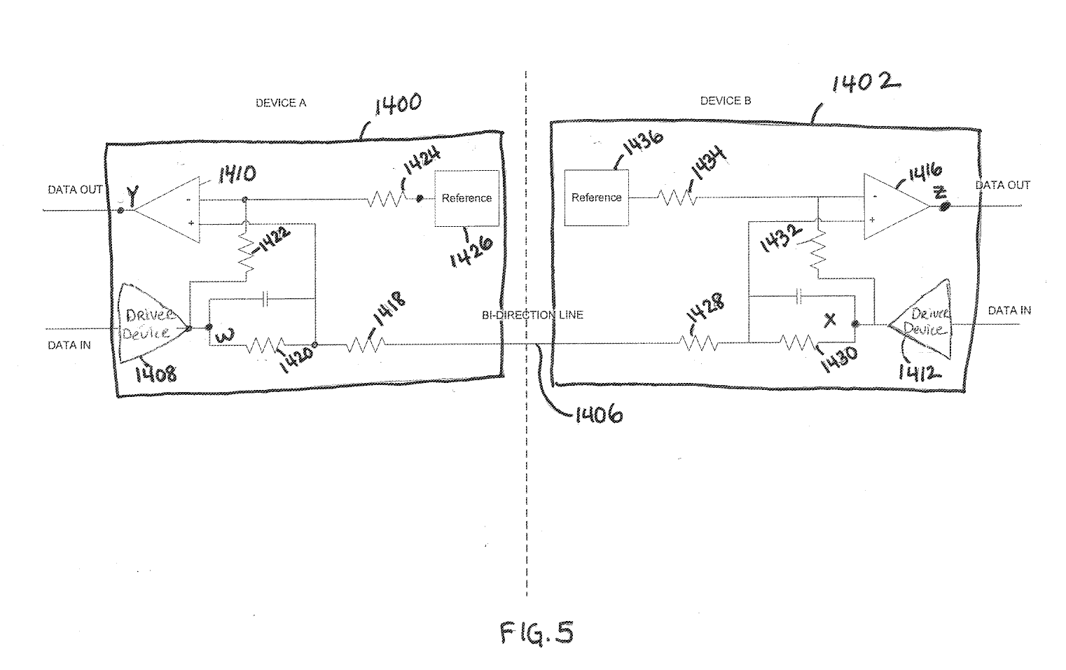

Referring now to FIG. 5, a communication line 1406 is used for bi-directional communication between devices 1400, 1402. In the example of FIG. 5, the communication line 1406 includes a half-duplex communication line. The device 1400 includes a driver device 1408 and a receiver 1410. The device 1400 also includes resistors 1418, 1420, 1422, 1424 and reference device 1426. The device 1402 also includes a driver device 1412 and a receiver 1416. The device 1402 also includes resistors 1428, 1430, 1432, 1434 and reference device 1436.

FIG. 5 includes nodes W, X, Y, Z. Node W includes a voltage value that is indicative of the output of the driver device 1408. Node X includes a voltage value that is indicative of the output of the driver device 1412. Node Y includes a voltage value that is indicative of the output of receiver 1410. Node Z includes a voltage value that is indicative of the output of receiver 1416.

In the example of FIG. 5, driver devices 1408, 1412 are intermittently (e.g., periodically or continuously) transmitting signals. In another example, driver devices 1408, 1412 also may simultaneously transmit signals. In an example, the driver device 1408 is coupled to the receiver 1410. Through the connection, the driver device 1408 transmits signals to the receiver 1410. The driver device 1408 is also coupled to the receiver 1416 through the communication line 1406. Through the communication line 1406, the driver device 1408 transmits signals to the receiver 1416.

In an example, the driver device 1412 is coupled to the receiver 1416. Through the connection, the driver device 1412 transmits signals to the receiver 1416. The driver device 1412 is also coupled to the receiver 1410 through the communication line 1406. Through the communication line 1406, the driver device 1412 transmits signals to the receiver 1410.

While the receiver 1410 is coupled to the driver device 1408, the receiver 1410 is also configured to listen for signals sent from the diver device 1412 over the communication line 1406. The receiver 1410 receives as input at the “−” terminal a voltage value that is at least partly based on the voltage value transmitted by the driver device 1408 and the reference device 1426. The receiver 1410 receives as input at the “+” terminal a voltage value that is at least partly based on the voltage value transmitted by the driver device 1412 and the driver device 1408, as described in further detail below. By comparing the two inputs received at the terminals, the receiver 1410 determines a logic state of the driver device 1412. In an example, values for the resistors 1418, 1420, 1422, 1424 and for the reference voltage value of the reference device 1426 are selected to promote a logic state output of the receiver 1410 matching the logic state of the driver device 1412.

In an example, the resistors 1418, 1420 generate a voltage divide between the voltage transmitted by the driver device 1408 and the communication line 1406. The voltage value on the communication line 1406 is determined by a voltage divider between the output of the driver device 1408 and the output of the driver device 1412. The value of the resistors 1420, 1418, 1418, 1430 contribute to the amount of division. The receiver 1410 receives as input at the “+” terminal a signal indicative of the value of voltage divide between the voltage transmitted by the driver device 1408 and the driver transmitted by the driver device 1412.

Resistors 1422, 1424 generate a voltage divide between the voltage out of the driver device 1408 and voltage out of the reference device 1426. The receiver 1410 receives as input at the “−” terminal a signal indicative of a value of the voltage divide between the voltage at the output of the driver device 1408 and voltage at the output of the reference device 1426. The receiver 1410 compares the inputs received at the terminals. Based on the comparison, the receiver 1410 determines a logic state of the driver device 1412. At node Y, the receiver 1410 outputs a value indicative of the logic state of the driver device 1412.

In an example, the values of resistors 1418, 1420, 1422, 1424, 1428, 1430, 1432, 1434 and the value of reference voltage at references devices 1426, 1436 are selected in accordance with the below values at nodes W-Z as indicated in Table 2.

TABLE 2

| Input | | Output | |
|---|---|---|---|
| W | X | Y | Z |
| 0 | 0 | 0 | 0 |
| 0 | 1 | 1 | 0 |
| 1 | 0 | 0 | 1 |
| 1 | 1 | 1 | 1 |

In one example, resistors 1418, 1420, 1428, and 1430 have values of 1000 ohms. Resistors 1422 and 1432 have values of 500 ohms. Resistors 1424 and 1434 have values of 1500 ohms. Other values may be used in generating the input and output logic states in accordance with the above Table 2. Additionally, in this example, the driver devices 1408, 1412 are configured to transmit low voltage values of 0V and high voltage values of 5V. The reference voltage values of each of reference devices 1426, 1436 are 2.5V.

As illustrated in the above Table 2, the values at nodes W, X are used as inputs to the receivers 1410, 1416. The values at nodes Y, Z are indicative of outputs of the receivers 1410, 1416, respectively.

As previously described, the receiver 1416 is configured to listen for signals transmitted from the driver device 1408, e.g., while also receiving signals from the driver device 1412. In another example, the receiver 1416 is configured to listen for signals on the communication line 1406 that are affected by the driver device 1408. In this example, the values of resistors 1428, 1430, 1432 and 1434 are selected to work in conjunction with resistors 1420, 1418, the reference voltage value of reference device 1436 and the high and low voltage values of driver devices 1412, 1408 to promote the voltage value transmitted by the driver device 1408 overriding the voltage value transmitted by the driver device 1412. Based on this configuration, the receiver 1416 is configured to output a logic state based on the inputs to its terminals that matches the logic state of the driver device 1408.

In an example, the driver devices 1408, 1412 receive a high and a low logic state. When the driver devices 1408, 1412 are in a high logic state, the driver devices 1408, 1412 drive and receive a high logic state. When the driver devices 1408, 1412 are in a low logic state, the driver devices 1408, 1412 drive and receive a low logic state.

In this example, when the driver device 1408 is in a high logic state, the receiver 1416 also outputs a high logic state. In an example, there may be a delay through the communication line 1406 (e.g., based on a length of the communication line 1406) before the receiver 1416 changes logic states from a low logic state to a high logic state. When the driver device 1408 is in a low logic state, the receiver 1416 also outputs a low logic state. Based on the corresponded between the logic states of the receiver 1416 and the driver device 1408, the values at node W match the values at node Z, as illustrated in the above Table 2.

Similarly, the receiver 1410 is configured to listen for signals transmitted from (and/or affected by) the driver device 1412, e.g., while also receiving signals from the driver device 1410. In this example, the values of resistors 1418, 1420, 1422 and 1424 are selected to work in conjunction with resistors 1428, 1430, the reference voltage value of the reference device 1426, and high and low voltage values of the driver devices 1408, 1412 to promote the voltage value transmitted by the driver device 1412 overriding the voltage value transmitted by the driver device 1408. Based on this configuration, the receiver 1410 is configured to output a logic state based on the inputs to its terminals that matches the logic state of the driver device 1412. In this example, when the driver device 1412 is in a high logic state, the receiver 1410 also outputs a high logic state. When the driver device 1412 is in a low logic state, the receiver 1410 also outputs a low logic state. As previously described, there may be a delay through the communication line 1406 before the receiver 1410 changes logic states. Based on the correspondence between the logic states of the receiver 1410 and the driver device 1412, the values at node X match the values at node Y, as illustrated in the above Table 2.

The techniques described in the above-passages are not limited to a disk drive testing system with disk drives and test electronics. Rather, the foregoing techniques generally pertain to any combination of communications, analog and/or digital information from multiple sources that share a single connection/communication line. In an example, any board, device, and/or circuit may be used for the external device 1106 and/or the test electronics 1102 of FIGS. 3 and 5. For example, the above-described techniques may be used for multiplexing full-duplex serial communications lines onto a half-duplex (e.g., shared) transceiver. Additionally, various combinations of resistors in various arrangements may be used to achieve the results of FIGS. 3 and 5. In an example, an AC coupling could be used rather than a resistor.

The techniques described herein may be performed by a computer (not shown), e.g., by sending signals to and from a contact pad on the formation electronics board in the contact assembly. The techniques described herein may be performed using hardware or a combination of hardware and software. In this regard, any of the techniques performed by the system described herein can be implemented, at least in part, via a computer program product, e.g., a computer program tangibly embodied in an information carrier, such as one or more machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

In an example, the techniques described herein can be used in various types of transmission medium that has energy transferred from one point to another point. For example, the techniques described herein can be used in transferring light energy on a communication line (e.g., an same optical transmission path) with a transmitter and a receiver on both ends of the same optical transmission path.

Actions associated with implementing all or part of the functions can be performed by one or more programmable processors executing one or more computer programs to perform the functions of the calibration process. All or part of the functions can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Components of different embodiments described herein may be combined to form other embodiments not specifically set forth above. Components may be left out of the structures described herein without adversely affecting their operation. Furthermore, various separate components may be combined into one or more individual components to perform the functions described herein. Other embodiments not specifically described herein are also within the scope of the following claims.

What is claimed is:

1. A system comprising:
a driver device configured to transmit a first signal through a communication line to a device that is external to the system;
wherein the communication line is configured to (i) receive signals from the system and to transmit signals to the system, and (ii) receive signals from the device that is external to the system and to transmit signals to the device that is external to the system;
a reference device configured to generate a reference value; and
a receiver configured to:
receive, through the communication line, a second signal affected by an output from the device that is external to the system; and
determine a logic state of the device external to the system based on:
a value associated with the second signal on the communication line;
a value associated with the first signal transmitted by the driver device; and
the reference value generated by the reference device.

2. The system of claim 1, wherein the receiver is further configured to:
receive a value that is derived from the value associated with the second signal on the communication line and the value associated with the first signal transmitted by the driver device.

3. The system of claim 2, wherein the value received by the receiver comprises a first value, and wherein the receiver is further configured to:
receive a second value that is derived from the reference value and the value associated with the first signal transmitted by associated with the driver device.

4. The system of claim 3, wherein the receiver is further configured to:
compare the first value to the second value.

5. The system of claim 4, wherein determination of the logic state based on comparison of the first value to the second value.

6. The system of claim 1,
wherein the value associated with the second signal on the communication line comprises one or more of a voltage value or a current value;
wherein the value associated with the first signal transmitted by the driver device comprises one or more of a voltage value or a current value; and
wherein the reference value generated by the reference device comprises one or more of a reference voltage value or a reference current value.

7. The system of claim 1, wherein the communication line comprises a half-duplex communication line.

8. The system of claim 1, wherein the device that is external to the system comprises one or more of a disk drive, a memory drive, or a solid state drive.

9. The system of claim 1, wherein the logic state comprises one or more of a high logic state and a low logic state.

10. The system of claim 3, wherein at a first time:
the first value is greater than the second value; and at a second time:
the value of the driver device changes relative to the value of the driver device at the first time; and
the first value remains greater than the second value.

11. The system of claim 3, wherein at a first time:
the first value is less than the second value; and at a second time:
the value of the driver device changes relative to the value of the driver device at the first time; and
the first value remains less than the second value.

12. The system of claim 3, wherein the logic state of the device that is external to the system is based on the second value and the reference value.

13. The system of claim 3,
wherein the first signal adjusts the first value in accordance with a first relationship;
wherein the first signal adjusts the second value in accordance with a second relationship;
wherein the first relationship is between the first value and the second value;
wherein the second relationship is between a value affected by the device that is external to the system and the reference value; and
wherein the first relationship is dependent on the second relationship.

14. A system comprising:
a first device comprising a first receiver and a first driver device;
a second device comprising a second receiver and a second driver device; and
a communication line for communication between the first device and the second device;
wherein the first receiver is configured to determine a first logic state of the second driver device independent of a second logic state of the first driver device; and
wherein the second receiver is configured to determine the second logic state of the first driver device independent of the first logic state of the second driver device.

15. The system of claim 14,
wherein the first driver device is configured to transmit one or more first signals from the first device to the second device over the communication line;
wherein the first receiver is configured to receive one or more second signals from the second device over the communication line;
wherein the second driver device is configured to transmit one or more third signals from the second device to the first device over the communication line; and
wherein the second receiver is configured to receive one or more fourth signals from the first device over the communication line.

16. The system of claim 15, wherein the first logic state comprises one of a high logic state or a low logic state.

17. The system of claim 14, wherein the first driver device is configured to transmit one or more first signals to the second receiver device over the communication line at a substantially simultaneous time as the second driver device is configured to transmit one or more second signals to the first receiver device over the communication line.

18. A method implemented by a first device, comprising:
receiving, over a communication line, a signal specifying a first value, wherein the communication line is configured for bi-directional communication between the first device and the second device, and wherein the signal is affected by an output of the first device;
obtaining a second value from a driver device;
obtaining a reference value; and
determining, based on the first value, the second value, and the reference value, a logic state of the second device.

19. The method of claim 18, further comprising:
generating a first summation value based on the first value and the second value;
generating a second summation value based on the second value and the reference value; and
comparing the first summation value to the second summation value;
wherein determining comprises:
determining based on comparing.

20. The method of claim 19, wherein the first summation value comprises the first value adjusted by a first amount, with the first amount based on the second value;
wherein the second summation value comprises the reference value adjusted by a second amount, with the second amount based on the second value; and
wherein the first amount offsets the second amount.

21. The method of claim 20, wherein comparing the first summation value to the second summation value is substantially the same as comparing a value of a driver of the second device to the reference value.

22. The method of claim 18, wherein the logic state comprises one of a high logic state or a low logic state.

23. The method of claim 18, wherein:
the first value comprises one or more of a first voltage value or a first current value;
the second value comprises one or more of a second voltage value or a second voltage value; and
the reference value comprises one or more of a reference voltage value or a reference current value.
